(19) United States
(12) Patent Application Publication
(10) Pub. No.: US 2005/0095332 A1
(43) Pub. Date: May 5, 2005

(54) Extraction of phenolic antioxidants

(76) Inventor: Roger Anthony Stanley, Auckland (NZ)

Correspondence Address: JACOBSON HOLMAN PLLC, 400 SEVENTH STREET N.W., SUITE 600, WASHINGTON, DC, 20004, US

(21) Appl. No.: 10/494,370

(22) PCT Filed: Nov. 15, 2002
(86) PCT No.: PCT/NZ02/00253

(30) Foreign Application Priority Data
Nov. 15, 2001 (NZ) 515523

(51) Int. Cl. A23P 1/00

(52) U.S. Cl. 426/481

(57) ABSTRACT

Procedures for deriving antioxidant phenolics from fruits and/or vegetables reliant upon milling to an aqueous slurry, subjection in the resultant aqueous phase to temperatures in the range of from 125° C. to 220° C. so as to derive in solution phenolics from the fruit and/or vegetable material, and thereafter some procedure of harvesting of the antioxidant phenolic composition. Such products in a powder, liquid concentrate or solution form are capable of being ingested for the purposes of ameloriating the health damaging effects of free radicals in the body, or being incorporated into food stuffs or cosmetics to act as antioxidants to prevent oxidative deteriation in the products such as the formation of off-flavours.

### TECHNICAL FIELD

The invention provides a method for extracting phenolic compounds (preferably antioxidant phenolic compounds) from plant materials with water only and does not need the use of organic solvents. The invention greatly increases the yield of phenolics bound within the plant matrices. The invention also consists of phenolics thus extracted.

### BACKGROUND OF INVENTION

1. Field of Invention

The present invention relates to the high temperature/pressure aqueous extraction of phenolic compounds from plant material, without the use of organic solvents.

2. Prior Art

Processes for the extraction of phenolics from plant materials such as pine bark and grape marc already exist. Examples of these follow:

U.S. Pat. No. 4,698,360: 100 kg of maritime pine bark reduced to a coarse powder is extracted with boiling water so as to collect 250 litres of liquid after having squeezed out the marc. The liquid cooled to 20° C. and filtered. To the filtrate sodium chloride is added up to saturation: instead of NaCl, 20% (weight/volume) of ammonium sulphate may also be added. The precipitate formed is eliminated by filtration. The filtrate is extracted thrice with ethyl acetate, which is used each time at the rate of 1/10 of the volume of the aqueous phase. The ethyl acetate collected is dried on anhydrous Na₂SO₄ and brought back to ⅕ of its volume by distillation under reduced pressure. It is then poured into three volumes of chloroform, while stirring mechanically. The proanthocyadins are precipitated. They are collected by filtration. Redissolution in ethyl acetate and a new precipitation in chloroform may purify them. They are finally washed with chloroform and dried at reduced pressure in a heating chamber not exceeding 50° C.

U.S. Pat. No. 5,968,517: Process for extraction of proanthocyanidins from botanical material. A method for extraction and isolation of proanthocyanidins from biological material. The method includes the steps of hot water extraction of the material after comminution using deoxygenated water, separation of the solids from the liquor, concentration of liquor into a concentrated solution and waste streams, and drying the concentrated solution to a solid product. The hot water can be recycled. The residue results in a usable by-product and the tannins can be extracted from the tannin-rich waste stream. The most preferred biological material is bark from Pinus radiata trees which are 15 years old, the bark most optionally coming from the upper portion of the tree.

PCT/AU01/00016: A 26 g sample of plant leaves is mixed with 52 g acid washed white sand and ground in a mortar and pestle. The ground leaf and sand mixture is then heated for 20 minutes at 62?C. 5M NaOH is added to raise the pH of the suspension to pH 12.0. The suspension is coarse filtered through a triple layer of fine gauze. The pH is adjusted to pH 3.5. The pH 3.5 mixture is kept at 1° C. for 48 hours then concentrated by partial freezing of the solution and separation of the ice the ice formed so the final volume is 100 mL. The remaining solution and precipitate are filtered through filter paper. The filter paper and retained precipitate are dried at 40° C. and isoflavone content measured.

Ito S., Journal of the Japan Wood Research Society, 1995, 41:5, 498-504: Steaming of Acacia mearnsii bark is done to increase the yield of condensed tannins from the bark and to improve their tannic characteristics. Bark is steamed at 180° C. and 220° C. and the residue extracted with 70% acetone. This markedly increases the amount of and tannins extracted from the bark. Furthermore, the protein absorbing capacities of the condensed tannins also increased with steaming before extraction with acetone.

U.S. Pat. Nos. 6,001,256 and 6,352,644: Each discloses extraction of biologically active organic compounds (viz. volatile flavour and fragrance compounds) from rosemary using subcritical water at both 100° C. and 200° C. There is also disclosure of mono-terpenes at 200° C.

U.S. Pat. No. 6,238,673: Make use of ion exchange to extract phenolics from grape juices and wines an example follows. Preparation of Composition from Red Wine with a High Flavonol Content. Californian Barbera red wine was chosen for the method of manufacture because of its high flavonol content. It contained 7.5 mg/L myricetin glycosides, 40.7 mg/L quercitin glycosides, 1.5 mg/L myricetin, 9.7 mg/L quercitin, 0.8 mg/L kaempferol. The total flavonol content was calculated as 44.3 mg aglycone/L. The wine had a total polyphenol content of 1.28 g/L. The method of manufacture is as follows: A 500 ml column of Diaion™. HP-20 resin was conditioned with 2 bed volumes (by) of 12% alcohol (4.5 by/hr). 5 L of Barbera wine were added slowly to the column (about 4-5 by/hr) followed by a de-ionized water rinse (2 by). The polyphenols were eluted with 1.1 L aqueous ethanol (75% v/v ethanol) and evaporated using a rotary vaporator under vacuum. A dry power was obtained by adding excess absolute ethanol and evaporating under vacuum. The process gave a red powder, readily soluble in water. The polyphenol content of the red powder obtained was 60% w/w with a yield of 1.34 g powder/L wine. The total flavonol content of the powder was 31.3 mg aglycone/g (3.13% w/w) or 5.2% flavonol w/w total polyphenols.

Inoue S, Asaga M, Ogi T, Yazaki Y., Holzforschung, 1998, 52:2, 139-145: Radiata pine bark was extracted using hot compressed water with or without 1% NaOH at temperatures of 100° C. and higher under different pressure for various holding times. The yields of extractives and polyflavanoids obtained from the extraction of the bark using hot compressed water without NaOH were much lower than those from conventional extraction at ambient pressure. This result confirmed previous experience. However, when 1% NaOH (based on weight of the oven dried bark) was added to the compressed water system, the yields of the extractives and polyflavanoids increased remarkably. The highest yield (31.3%) of the extractives was obtained at a peak temperature of 140° C. and a pressure of 10 atmospheres followed by immediate cooling. Furthermore, the bark particle size and the ratio of bark to solvent affected to a much lesser extent the yield of extractives in this new method, compared with to conventional methods. The solubility behaviour of the tannin extracts in the hot compressed water is discussed in relation to the extractive yield from the extraction of the bark at temperatures higher than 100° C. and at pressure higher than ambient.

Dix B, Marutzky R., Holz als Roh und Werkstoff, 1982, 41:2, 45-50: From the bark of indigenous Norway spruce and Scots pine and radiata pine as much of 68%-75% of the material was dissolved by sequential extraction with solvents of increasing polarity and diluted alkali. The extraction procedure greatly influenced yield and reactivity of the extracts towards formaldehyde. Under favourable conditions hot water treatment yielded about 14%-16% extracts from spruce and radiata pine and about 6% for Scots pine. Using different chemicals such as alkali and sulphite, polyphenols with higher yield and reactivity towards formaldehyde were extracted. Extraction with a small amount of alkali considerably increased the yield and reactivity of the extracts.

ES Patent 2130092: 100 kg of black wine grapes are hydraulic pressed juiced) resulting in a pulp with 50% to 80% moisture content. This pulp is then passed through a vibrating sieve with holes 4 mm to 10 mm diameter. The seeds and stems are retained in the sieve and grape skin is collected with a yield of approximately 38 kg. The skin material is then dried in a rotating drier with hot air, the temperature of the product (skin) is between 40° C. and 120° C., and has a residence time in the drier of 60 to 120 minutes, resulting in a moisture at the drier outlet of below 15%. This dried material is then passed through a vibrating sieve with holes 1.5 mm to 0.2 mm in diameter, approximately 14 kg of product is collected under the sieve.

### DESCRIPTION OF THE INVENTION

The present invention extracts phenolics from plant material with high temperature (up to 220° C.) and elevated pressure water. Whilst we have found benefit with temperatures over 100° C. we have a preference for the elevated temperatures 125-220° C. where large increases in soluble phenolic compounds (antioxidant) are unexpectedly found that cannot be recovered by organic solvent extraction alone. The success is probably due to a combination of because (a) they are heat solublised, (b) heat hydrolysed to release them and (c) reacted by the heat to form new soluble compounds.

Preferably said phenolic are antioxidants.

“Antioxidants” and “antioxidant” in this context are those substances able to inhibit free radical damage to biochemicals such as lipids, proteins, nucleic acids, sugars, and aromatic molecules by reacting with the free radicals to form a more stable product. Such antioxidants are commonly polyphenolic compounds of many different classes. They may be artificial e.g. BHT, BHA, propylgallate or natural such as caffeic acid, gallic acid, chlorogenic acid, gallocatechin, catechol, quercetin and polymerise such as proathocyanidins, flavanoids, hydroxycinnamic acids, hydroxbenzoic acids. They inhibit oxidative processes during storage and supply dietary antioxidants to combat free radicals in the body.

“Phenolics” and “phenolic” means all the classes of molecules that have a phenolic ring structure such as anthocyanins, flavonoids, proanthocyanidins and tannins.

The antioxidant phenolics of the present invention preferably are of a type capable of being ingested orally whether as a solution, powder or otherwise, whether in a convenient dosage form such as a capsule, tablet or otherwise or as an additive to a foodstuff, drink or other carrier, for the purpose of acting as an antioxidant in the body, eg; with a view to scavenging free oxygen radicals.

As such the procedures of the present invention provide for the harvesting of worthwhile materials from fruit materials and/or vegetable materials that might otherwise be lost to the food chain, eg; skins, damaged fruit or vegetable material, etc.

“Fruit and/or fruit material” includes whole, peeled, part, crushed, bruised, peel, skins, pods, etc. of any suitable fruit including but not limited to those disclosed herein, eg; apples, kiwifiut, grapes, blueberries, pears, quince, cherries, persimmons, citrus, tomatoes, etc. Ideally the recovery is from processing wastes. Similarly for “vegetable and/or vegetable material”.

The vegetable types can be any providing an available supply of the antioxidant phenolics and may include potatoes, onions, spinach, pumpkin, beans, carrots, peas, kumara, etc. and/or processing waste, etc. thereof.

The preferably pressures, temperatures and time requirements may vary from those disclosed in respect of individual fruit or fruit material herein for corresponding quantities of individual vegetables or other fruits.

The present invention recognises that at such elevated temperatures and elevated pressures the phenolics, which are bound within the plant matrices are readily, released. This we believe in part may be due to hydrolysis of bonds between phenolics and macromolecules within the plant matrix i.e. proteins, cellulose, sugars. We believe it may also be in part due to our belief that with increasing temperature and pressure the solubility of phenolics (and other organics) in water increases, thus allowing more phenolics to be extracted into the soluble phase during the extraction process and preferably without the use of non-aqueous solvents.

Notwithstanding reliance on water at high temperature and high pressure water the use of optional (such as acids) may be used in the high temperature extraction and/or may be used subsequently for elution thereby
increasing the rate of release and/or yield of the phenolic antioxidant molecules by increasing the hydrolysis of the plant matrix and increase the solubility of the released antioxidants.

The inclusion of organic solvents (such as ethanol) as an elution agent may be used to assist the ability of the released antioxidants (ie; released by the high temperature procedure) to stay in solution when the solution is cooled below the saturation point for water.

In yet a further aspect the present invention consists in a method of deriving antioxidant phenolic compounds from an unfermented by-product of a fruit selected from one or more of a pomace, core, skin and peel (“fruit material(s)”), said method comprising or including milling or mechanically disrupting the fruit material(s),
subjecting the resultant material(s) as a non alkaline aqueous slurry to temperature(s) above 100° C. in a high temperature/elevated pressure system thereby to derive antioxidant phenolic compounds in solution, and
separating the or a solution containing the antioxidant phenolic compounds from at least most of any residual solids.

Preferably the high temperature/elevated pressure system is at temperature(s) in the range 125° C. to 220° C. to derive the antioxidant phenolic compounds in solution.

Preferably the range is from 130° C. to 220° C.

Preferably the separation of the solution from at least most of any residual solids material follows a cool down from the conditions of the high temperature/elevated pressure system.

Preferably the product of the process is a powder or a liquid concentrate and the process includes a step or steps to derive that outcome.

Preferably the method comprises or includes
milling a slurry of the fruit material(s),
subjecting the resultant non alkaline slurry (optionally with additional water addition) in a high temperature/elevated pressure system to temperature(s) over time sufficient to'derive in acid pH conditions the antioxidant phenolic compounds in solution, and
treating the mixed phase materials from or of the system, after cool down from above atmospheric pressure sustained temperature(s), to said separating step and optionally other steps (in any time sequence) to derive a powder or liquid concentrate of the antioxidant phenolic compounds.

In another aspect the invention is a method of deriving antioxidant phenolic compounds from an unfermented processing by-product of a fruit selected from one or more of a pomace, core, skin and peel (“fruit material(s)”), said method comprising or including
(i) milling or otherwise mechanically treating to a similar affect an aqueous slurry of the fruit and/or fruit material,
(ii) subjecting the resultant non alkaline slurry (optionally with the addition of further water) to temperature(s) above 100° C. in a high temperature/elevated pressure system thereby over time deriving in acid pH conditions antioxidant phenolic compounds from the fruit and/or fruit materials in solution, and
(iii) separating the or a solution containing the antioxidant phenolic compounds from at least most of any residual solids material in the aqueous system resulting from the use of the high temperature/elevated pressure system or isolating the antioxidant phenolic compounds either in a liquid concentrate substantially free of solids or as a powder.

Preferably the temperature(s) are above 125° C.

In still another aspect the invention is a method of deriving antioxidant phenolic compounds from an unfermented processing by-product of a fruit selected from one or more of a pomace, core, skin and/or peel from fruit (“fruit material(s)”),
said method comprising or including
(i) milling or mechanically disrupting (optionally in water) the fruit material(s),
(ii) subjecting the resultant material(s) in non alkaline conditions in water and/or as a non alkaline slurry to a predetermined temperature or predetermined temperatures above 100° C. for a predetermined time or times in a high temperature/elevated pressure system thereby to derive in acid pH conditions antioxidant phenolic compounds in solution, and
(iii) separating the or a solution containing the antioxidant phenolic compounds from at least most of any residual solids material or isolating the antioxidant phenolic compounds either in a liquid concentrate substantially free of solids or as a powder.

Preferably step (i) involves milling the water in to produce a slurry.

Preferably step (i) is of a predetermined amount of fruit material(s).

Preferably step (ii) is in a system at from 125° C. to 220° C.

Preferably step (iii) is at atmospheric pressure or below.

In yet a further aspect the present invention consists in a method of deriving antioxidant phenolic compounds from an unfermented processing by-product of a fruit selected from one or more of a pomace, core, skin and peel from fruit (“fruit material(s)”,
said method comprising or including
(i) milling an aqueous slurry of the fruit material(s),
(ii) subjecting the milled non alkaline slurry (optionally with the addition of further water) to a predetermined temperature or predetermined temperatures above 100° C. for a predetermined time or times in a high temperature/elevated pressure system thereby over time deriving at acid pH conditions antioxidant phenolic compounds from the fruit and/or fruit material in solution, and
(iii) separating the or a solution containing the antioxidant phenolic compounds from at least most of any solids in the aqueous system resulting from the use of the high temperature/elevated pressure system or isolating the antioxidant phenolic compounds either in a liquid concentrate substantially free of solids or as a powder.

Preferably in any of the steps and/or parameters and/or any additional steps are substantially as hereinbefore described with or without reference to any one or more of the accompanying drawings.

Preferably the fruit and/or fruit material is of any of the kinds previously defined.

In still a further aspect the present invention consists in a method of deriving antioxidant phenolic compounds from an unfermented processing by-product of an edible vegetable selected from one or more of a pomace, core, skin and/or peel from a vegetable (“vegetable material(s)”), said method comprising or including
(i) milling or otherwise mechanically treating to similar affect the vegetable material(s),
(ii) subjecting the resultant material(s) as a non alkaline aqueous slurry to temperature(s) above 125° C. in a high temperature/elevated pressure system thereby to derive at acid pH conditions antioxidant phenolic compounds in solution, and
(iii) separating the or a solution containing the antioxidant phenolic compounds from at least most of any residual solids.

Preferably the method comprises
milling an aqueous slurry of the vegetable material(s),
subjecting the resultant slurry (optionally with additional water addition) in a high temperature/elevated pressure system to temperature(s) over time sufficient to derive the antioxidant phenolic compounds in solution, and
treating the mixed phase materials from or of the system, after cool down from above atmospheric pressure sustained temperature(s), (in any time sequence) to said separating step and optionally other steps to derive a powder or liquid concentrate of the antioxidant phenolic compounds.

Preferably said antioxidant phenolic compounds derived from an unfermented processing by-product of a fruit selected from one of more of a pomace, core, skin and peel, such materials being soluble in water at a temperature 100° C. or below, said antioxidant phenolic compounds having been derived by release and/or reaction from the fruit materials in a non alkaline aqueous system at a temperature or temperatures above 125° C.

Preferably said antioxidant phenolic compounds derived from an unfermented processing by-product of an edible vegetable selected from one or more of a pomace, core, skin and peel from vegetable and/or vegetable material, such materials being soluble in water at a temperature 100° C. or below, said antioxidant phenolic compounds been derived by release and/or reaction from the fruit and/or fruit materials in an aqueous system at a temperature or temperatures in the range from 125° C. to 220° C.

Preferably an antioxidant for mammalian ingestion, antioxidant phenolic compounds or claim 19, 20, 21 or 22.

In another aspect the present invention consists in a method of extracting phenolics from plant material which comprises subjecting the plant material to water at an elevated temperature and pressure.

Preferably said elevated temperature is up to about 280° (and preferably below charring reaction temperature(s)).

Preferably said temperature is up to 225° C. and the elevated pressure is up 24 bar gauge.

Preferably the extraction takes place with the water providing a slurry.

Preferably the extraction takes place in a high temperature/pressure reactor.

In yet a further aspect the present invention consists in a method as previously described wherein the temperature is at least 130° C. and preferably is from about 180° C. to about 225° C.

In another aspect the invention consists in a method of extracting phenolics from plant material into a solution comprising or including
subjecting the plant material to high temperature elevated pressure water extraction of the phenolics (optionally in the presence of at least one additive (eg; acid(s)) to derive the phenolics solubilized in water at elevated temperature(s), and
maintaining the phenolics in solution as the water cools and/or eluting more of the phenolics by the addition of a suitable solvent (eg; organic solvents typified by ethanol).

In a further aspect the present invention consists in a yellow coloured solution of phenolics extracted from plant material, said solution resulting from the employment of a process in accordance with the present invention. Black coloured insolubles may be present.

Preferably the pH of the extract (eg; if driven by release of organic acids) is about 3.4. Nevertheless acid addition may affect such pH as might other additions (whether prior to or subsequent to phenolic(s) release).

In a further aspect the present invention consists in antioxidant phenolics extracted from plant material where the extraction has been in water at an elevated temperature and an elevated pressure (eg; preferably by any procedure as hereinbefore described).

Characteristics of Extract

Extraction Process Description:

A known mixture of raw material and water is made up e.g. 200 g of apple peel made up to 2 L with water.
This mixture is passed through a stone mill until a homogenous fine particle size is achieved e.g. 16 times, and mixture becomes slurry.
The slurry is loaded into the reactor, in this case a 2.5 L vessel capable of being heated up to 225° C., 24 bar pressure.
The loaded reactor is heated to the desired temperature between 20° C. and 225° C. and held there for the desired time to carry out the extraction. Ramped heating i.e. different temperature holding points may be used e.g. 100° C. for 1 hour then 130° C. for 1 hour.
The reactor is then allowed to cool to around 100° C. before opening to prevent excessive steam flash off, unless this is desired to reduce extract mixture volume.
The extracted slurry is removed while hot and hot filtered (eg; with paper filter) to remove the insoluble fraction.
The filtered supernatant was optionally freeze-dried to a powder.
   General Characteristics

At low temperatures (less than about 130° C.) the extract colour depends on the colour of the starting plant material. At the higher temperatures (above about 180° C.) most of the extracts are a yellow coloured solution with black coloured insolubles. The pH of the extracts is around pH 3.4.

Sampling:

Samples could be taken at any time during the reaction even though the vessel is under pressure by means of a step-down double valve system.
Soluble activity was determined on the clear supernatant after centrifugation
Total activity was determined on the clear supernatant after extraction in 50% methanol at 20° C. for 2 hours followed by centrifugation.
   Analysis Methods:
The Folin-Ciocalteu assay of Singleton & Rossi (1965, Am J Enol Vitic 16 144-158). (Folin assay) was used to determine the total content of mono- and polyphenolic compounds in the extracts. The final results (F-C value) are expressed using Catechin equivalents antioxidant capacity (microgram of Catechin per gram sample) based on comparison to a standard solution of catechin. The antioxidant potential of the extracts was measured by the FRAP assay of Benzie & Strain (1996, Anal Biochem 239 70-76).
   Results:

Kinetics of extraction of phenolic substances from apple pomace:

| | Time at | F-C assay |
|---|---|---|
| | temperature | (mg Catechin/g |
| Temp (° C.) | (minutes) | DW feed material) |
| 20 | 0 | 0.1 |
| 100 | 0 | 0.4 |
| 100 | 10 | 0.4 |
| 100 | 20 | 0.6 |
| 100 | 30 | 0.6 |
| 100 | 60 | 0.6 |
| 100 | 90 | 0.6 |
| 130 | 0 | 1.3 |
| 130 | 5 | 1.8 |
| 130 | 10 | 2.2 |
| 13 | 15 | 2.4 |
| 130 | 20 | 2.5 |
| 130 | 30 | 2.7 |
| 130 | 45 | 3.2 |
| 130 | 60 | 3.2 |
| 130 | 90 | 3.7 |
| 172 | 0 | 6.4 |
| 200 | 0 | 22.2 |
| 200 | 10 | 25.6 |
| 200 | 20 | 25.9 |
| 200 | 30 | 25.9 |
| 200 | 60 | 26.2 |
| 200 | 90 | 25.7 |

Source Material: Apple Pomace (Fuji) Waste from Juice Processing

The extraction kinetics show that after 20 minutes at 100° C. most of the reactive material has been solublised and there is little further change in reading between 20 minutes and 90 minutes. However results at 130° C. show that the extraction continues to generate new soluble reactivity for over 90 minutes. When the temperature is adjusted to 200° C. there is a large increase in assay reactivity but it stabilises inside 10 minutes.

Extraction of Phenolic Substances from Apple Peel:

F-C assay (mg Catechin/g
DW feed material)

| Temp (° C.) | Soluble | Total |
|---|---|---|
| 20 | 16.2 | 18.1 |
| 100 | 18.7 | 19.0 |
| 130 | 18.9 | 22.5 |
| 160 | 36.5 | 45.4 |
| 200 | 57.2 | 72.2 |

Source Material: Apple Peel (Granny Smith) in Water

F-C assay (mg Catechin/g
DW feed material)

| Temp (° C.) | Soluble | Total |
|---|---|---|
| 20 | 10.8 | 14.3 |
| 100 | 13.7 | 15.2 |
| 130 | 20.3 | 22.4 |
| 200 | 52.4 | 67.4 |

Source Material: Apple Peel (Granny Smith) in Water. PH was Adjusted to 6.8 with Sodium Hydroxide Prior to Extraction.

The amounts of Folin reactive material for Granny Smith variety apple peel are similar whether the natural acidic pH is used or the pH is adjusted to pH 6.8 before extraction. Again the Folin values increase by a factor of 2 to 3, at a temperature above 130° C. compared to the amounts extracted at 100° C. or below. Folin reactive substances significantly increased by a factor of 2-3 after extraction at. 130° C. for 20 minutes.

The Folin readings for the granny smith peel extract are significantly higher compared to the pomaces (Braeburn and Fuji). This is believed to be due to that fact that a significant proportion of phenolics are found in the skin or peel of fruit.

Recovery of Additional Antioxidants from Apple (Braeburn) Pomace Previously Treated with Pectinases and Hot Water to Remove Antioxidants

F-C assay (mg Catechin/g
DW feed material)

| Temp (° C.) | Soluble | Total |
|---|---|---|
| 20 | 0.4 | 0.6 |
| 75 | 1.8 | 1.8 |
| 100 | 0.7 | 1.1 |
| Re-extract | | |
| 130 | 2.7 | 3.2 |

Source Material: Apple Pomace (Braeburn) Waste Left After Juice Extraction and Hot Water/Pectinase Enzyme Washing.

The Braeburn pomace was milled and sampled at 20° C., extracted at 75° C. for 1 hr then filtered and the solution tested. The slurry was then made back up to volume (2 L) and extracted at 100° C. and 130° C.

It can be seen that milling, alone at 20° C. does not significantly increase the amount of material extracted. However heating at 75° C. for 1 hour increases the amount of material extracted. A significant observation is that the Folin increases from 0.4 mgC/gDW solubles at 20° C., to 1.8 mgC/gDW at 75° C. Once the soluble material extracted at 75° C. is removed by filtering, and the left over solids are re-extracted, a significant amount of antioxidant and phenolic material is extracted at 130° C. The solubles at 130° C. are 2.7 mgC/gDW, therefore a total of 4.5 mgC/gDW of soluble phenolic material can be extracted from the Braeburn pomace, after it has been through a commercial juice extraction process.

Braeburn Pomace Re-Extract Freeze Dried Powders:

| | F-C assay (mg Catechin/g |
|---|---|
| Temp (° C.) | DW freeze dried powder) |
| 75 | 12.7 |
| 130 | 28.8 |

The freeze-dried extract taken from the 75° C. fraction has a phenolic content of 14 mgC/gDW, the 130° C. fraction has a phenolic content of 31 mgC/gDW, as shown by Folin assay. This means a total of 45 mgC/gDW powder can be extracted from the pomace after it has been though the commercial extraction process which should have removed most of the soluble phenolics.

Fuji Apple Pomace:

F-C assay (mg Catechin/g
DW feed material)

| Temp (° C.) | Soluble | Total |
|---|---|---|
| 20 | 0.4 | 1.0 |
| 100 | 1.2 | 2.1 |
| 130 | 2.5 | 3.7 |
| 200 | 15.4 | 18.3 |

Source Material: Apple Pomace (Fuji) Waste Left After Juice Extraction

The extract graph for Fuji apple pomace shows that there is a slight increase in the amount of material extracted between 20° C. and 130° C. The Folin increases from 0.39 mgC/gDW solubles at 20° C. to 2.47 mgC/gDW solubles at 130° C., an increase of over five times. Above 130° C. there is a large increase in the values. Folin solubles go up to 15.4 mgC/gDW at 200° C.

Apple Pomace (Fuji) Freeze-Dried Extract:

| | |
|---|---|
| | F-C assay (mg Catechin/g |
| Temperature of | DW extract powder) |

| extraction (° C.) | Mill | Not milled |
|---|---|---|
| 20 | 11.2 | |
| 100 | 10.4 | 9.5 |
| 130 | 13.4 | 15.7 |
| 200 | 187.6 | |

The Fuji apple pomace freeze-dried extract has a reactivity of around 3.2 mgC/gDW for the 20° C. milled sample; this increases to 18.8 mgC/gDW for the 130° C. milled extract. Milling has a significant effect on the extracts at 100° C., but minimal effect at 130° C.

Apple Core:

F-C assay (mg Catechin/g
DW feed material)

| Temp (° C.) | Soluble | Total |
|---|---|---|
| 20 | 3.5 | 3.5 |
| 100 | 4.0 | 4.8 |
| 130 | 6.6 | 7.7 |
| 210 | 43.1 | 58.2 |

Source Material: Apple Cores (Braeburn) Waste

There is a slight increase in Folin reactive substances from 20° C. to 130° C. Then at 205° C. there is a large increase to 43.1 gC/mgDW at 205° C. This is again a significant increase, of which the exact cause is unknown.

Kiwifruit Skin:

F-C assay (mg Catechin/g
DW feed material)

| Temp (° C.) | Soluble | Total |
|---|---|---|
| 20 | 14.7 | 17.2 |
| 100 | 31.4 | 69.6 |
| 130 | 45.0 | 72.7 |
| 205 | 52.0 | 84.7 |

Source Material: Green Kiwifruit (Actinidia deliciousa) Skin and Seed Waste After Puree Extraction.

The green kiwifruit skin extract again shows the trend of increasing activity with increasing temperature. However the increase from 20° C. to 130° C. is significantly larger compared with the apple based material extracts. The Folin solubles increase from 14.7 mgC/gDW at 20° C. to 45.1 mgC/gDW at 130° C., this slightly increases to 52.0 mgC/gDW at 205° C. The results show that green kiwifruit skin is a potential good yielding source of phenolic compounds, due to relatively high Folin readings at 20° C., 100° C. and 130° C.

Grape Pomace:

| | FRAP assay (mg Trolox/g | | F-C assay (mg Catechin/g | |
|---|---|---|---|---|
| | DW feed material) | | DW feed material) | |
| Temp (° C.) | Soluble | Total | Soluble | Total |
| 18 | 31.1 | 145.7 | 5.6 | 27.9 |
| 100 | 72.6 | 127.3 | 6.8 | 36.1 |
| 130 | 97.0 | 171.8 | 9.3 | 37.3 |
| 218 | 141.2 | 256.7 | 14.9 | 37.1 |

Source Material: Grape Marc (Riesling) Left After Juice Extraction for Wine Production

The Riesling pomace extracts have an increasing activity up to 100° C. as shown by the assays. At 130° C. the Folin values are similar. At 220° C. Folin values increase.

Blueberry Skin:

| | FRAP assay (mg Trolox/g | | F-C assay (mg Catechin/g | |
|---|---|---|---|---|
| | DW feed material) | | DW feed material) | |
| Temp (° C.) | Soluble | Total | Soluble | Total |
| 18 | 20.2 | 135.5 | 2.1 | 4.2 |
| 100 | 69.3 | 106.6 | 7.3 | 11.7 |
| 130 | 105.6 | 164.8 | 10.0 | 14.6 |
| 218 | 275.0 | 390.7 | 11.5 | 26.1 |

Source Material: Blueberry Skins and Seeds After Juice Production

The Folin results follow the trend of increasing in value with increasing extraction temperature. The Folin solubles increase from 2.06 mgC/gDW at 20° C. to 10.1 mgC/gDW at 130° C. They slightly increase to 11.6 mg/gDW at 220° C.

Separation Strategies:

Extracts can be further processed after high temperature recovery by any one or more of:
Heating to the desired temperature (optimally between 20-100° C. depending on the nature of the material being extracted) for the desired time (optimally 10 minutes to 1 hour) to solubilse the phenolics
Filtering off the extract and recovering it as a liquid
Optionally concentrating the liquid by evaporation or membrane processing to retain the phenolics or using evaporation to make a dried powder
Adding extra water and heating again at the higher temperature under pressure (optimally between 100° C. and 220° C.) for a desired time (optimally 10-90 minutes)
Then cooling to less thin 100° C., filtering off the insoluble materials and recovering the phenolics in the liquid fraction
Optionally further processing the liquid by evaporation or membrane processing to retain the phenolics or producing a dried powder by evaporation.

1. A method of deriving antioxidant phenolic compounds from an unfermented processing by-product of a fruit selected from one or more of a pomace, core, skin and peel (“fruit material(s)”), said method comprising
milling or mechanically disrupting the fruit material(s),
subjecting the resultant material(s) as a non alkaline aqueous slurry to temperature(s) above 100° C. in a high temperature/elevated pressure system thereby to derive antioxidant phenolic compounds in solution, and
separating the solution containing the antioxidant phenolic compounds from at least most of any residual solids.

2. The method of claim 1 wherein the high temperature/elevated pressure system is at temperature(s) in the range 125° C. to 220° C. to derive the antioxidant phenolic compounds in solution.

3. The method of claim 2 wherein the range is from 130° C. to 220° C.

4. The method of claim 1 wherein the separation of the solution from at least most of any residual solids material follows a cool down from the conditions of the high temperature/elevated pressure system.

5. The method claim 1 wherein the product of the method is a powder or a liquid concentrate and the method further comprises a step or steps to derive the powder or the liquid concentrate.

6. The method of claim 1 wherein the method comprises
milling a slurry of the fruit material(s),
subjecting the resultant non alkaline slurry (optionally with additional water addition) in a high temperature/elevated pressure system to temperature(s) over time sufficient to derive in acid pH conditions the antioxidant phenolic compounds in solution, and
treating the mixed phase materials from or of the system, after cool down from above atmospheric pressure sustained temperature(s), to said separating step and optionally other steps (in any time sequence) to derive a powder or liquid concentrate of the antioxidant phenolic compounds.

7. A method of deriving antioxidant phenolic compounds from an unfermented processing by-product of a fruit selected from one or more of a pomace, core, slain and peel (“fruit material(s)”), said method comprising
(i) milling or otherwise mechanically treating to a similar affect an aqueous slurry of the fruit and/or fruit material,
(ii) subjecting the resultant non alkaline slurry (optionally with the addition of further water) to temperature(s) above 100° C. in a high temperature/elevated pressure system thereby over time deriving in acid pH conditions antioxidant phenolic compounds from the fruit and/or fruit materials in solution, and
(iii) separating the solution containing the antioxidant phenolic compounds from at least most of any residual solids material in the aqueous system resulting from the use of the high temperature/elevated pressure system or isolating the antioxidant phenolic compounds either in a liquid concentrate substantially free of solids or as a powder.

8. The method of claim 7 wherein the temperature(s) are above 125° C.

9. A method of deriving antioxidant phenolic compounds from an unfermented processing by-product of a fruit selected from one or more of a pomace, core, skin and/or peel from fruit (“fruit material(s)”), said method comprising
(i) milling or mechanically disrupting (optionally in water) the fruit material(s),
(ii) subjecting the resultant material(s) in non alkaline conditions in water and/or as a non alkaline slurry to a predetermined temperature or predetermined temperatures above 100° C. for a predetermined time or times in a high temperature/elevated pressure system thereby to derive in acid pH conditions antioxidant phenolic compounds in solution, and
(iii) separating the solution containing the antioxidant phenolic compounds from at least most of any residual solids material or isolating the antioxidant phenolic compounds either in a liquid concentrate substantially free of solids or as a powder.

10. The method of claim 9 wherein the step (i) involves milling the water in to produce a slurry.

11. The method of claim 10 where step (i) is of a predetermined amount of fruit material(s).

12. The method of claim 9 wherein step (ii) is in a system at from 125° C. to 220° C.

13. The method of claim 9 wherein step (iii) is at atmospheric pressure or below.

14. A method of deriving antioxidant phenolic compounds from an unfermented processing by-product of a fruit selected from one or more of a pomace, core, skin and peel from fruit (“fruit material(s)”), said method comprising
(i) milling an aqueous slurry of the fruit material(s),
(ii) subjecting the milled non alkaline slurry (optionally with the addition of further water)
to a predetermined temperature or predetermined temperatures above 100° C. for a predetermined time or times in a high temperature/elevated pressure system thereby over time deriving at acid pH conditions antioxidant phenolic compounds from the fruit and/or fruit material in solution, and
(iii) separating the solution containing the antioxidant phenolic compounds from at least most of any solids in the aqueous system resulting from the use of the high temperature/elevated pressure system or isolating the antioxidant phenolic compounds either in a liquid concentrate substantially free of solids or as a powder.

15. The method of claim 1 wherein in any of the steps and/or parameters and/or any additional steps are substantially as hereinbefore described with or without reference to any one or more of the accompanying drawings.

16. The method as claimed in claim 1 wherein the fruit and/or fruit material is of any of the kinds previously defined.

17. A method of deriving antioxidant phenolic compounds from an unfermented processing by-product of an edible vegetable selected from one or more of a pomace, core, skin and/or peel from a vegetable (“vegetable material(s)”), said method comprising
(i) milling or otherwise mechanically treating to similar affect the vegetable material(s),
(ii) subjecting the resultant material(s) as a non alkaline aqueous slurry to temperature(s) above 125° C. in a high temperature/elevated pressure system thereby to derive at acid pH conditions antioxidant phenolic compounds in solution, and
(iii) separating the solution containing the antioxidant phenolic compounds from at least most of any residual solids.

18. The method as claimed in claim 17 wherein the method comprises
milling an aqueous slurry of the vegetable material(s),
subjecting the resultant slurry (optionally with additional water addition) in a high temperature/elevated pressure system to temperature(s) over time sufficient to derive the antioxidant phenolic compounds in solution, and
treating the mixed phase materials from or of the system, after cool down from above atmospheric pressure sustained temperature(s), (in any time sequence) to said separating step and optionally other steps to derive a powder or liquid concentrate of the antioxidant phenolic compounds.

19. Antioxidant phenolic compounds derived from a fruit where the derivation has involved the use of a method of claim 1.

20. Antioxidant phenolic compounds derived from a vegetable where the derivation has involved the use of claim 17.

21. Antioxidant phenolic compounds derived from an unfermented processing by-product of a fruit selected from one or more of a pomace, core, skin and peel, such materials being soluble in water at a temperature 100° C. or below, said antioxidant phenolic compounds having been derived by release and/or reaction from the fruit materials in a non alkaline aqueous system at a temperature or temperatures above 125°.

22. Antioxidant phenolic compounds derived from an unfermented processing by-product of an edible vegetable selected from one or more of a pomace, core, skin and peel from vegetable and/or vegetable material, such materials being soluble in water at a temperature 100° C. or below, said antioxidant phenolic compounds been derived by release and/or reaction from the fruit and/or fruit materials in an aqueous system at a temperature or temperatures in the range from 1250 to 220° C.

23. An antioxidant for mammalian ingestion comprises the antioxidant phenolic compounds of claim 19.

24. A capsule, tablet, foodstuff or drink including antioxidant compounds of claim 23.
